(19) United States
(12) Patent Application Publication
(10) Pub. No.: US 2010/0253700 A1
(43) Pub. Date: Oct. 7, 2010

(54) Real-Time 3-D Interactions Between Real And Virtual Environments

(76) Inventor: Philippe Bergeron, Woodland Hills, CA (US)

Correspondence Address: FISH & ASSOCIATES, PC;ROBERT D. FISH, 2603 Main Street, Suite 1000, Irvine, CA, 92614-6232, US

(21) Appl. No.: 12/752,822

(22) Filed: Apr. 1, 2010

Related U.S. Application Data
(60) Provisional application No. 61/211,846, filed on Apr. 2, 2009.

(51) Int. Cl. G09G 5/00; G03B 35/00

(52) U.S. Cl. 345/633; 353/7

(57) ABSTRACT

Systems and methods providing for real and virtual object interactions are presented. Images of virtual objects can be projected onto the real environment, now augmented. Images of virtual objects can also be projected to an off-stage invisible area, where the virtual objects can be perceived as holograms through a semi-reflective surface. A viewer can observe the reflected images while also viewing the augmented environment behind the pane, resulting in one perceived uniform world, all sharing the same Cartesian coordinates. One or more computer-based image processing systems can control the projected images so they appear to interact with the real-world object from the perspective of the viewer.

This application claims the benefit of priority to U.S. provisional application having Ser. No. 61/211,846, filed on Apr. 2, 2009. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is projected image technologies.

### BACKGROUND

Conventional methods of real environments interacting with virtual environments in films are well known. Older examples include “Who framed Roger Rabbit?” with traditional animation, or “Jurassic Park” with CGI animation. A recent example includes “The Incredible Hulk,” where the CGI Hulk interacts with his live-action love interest in the same 3D space. Sometimes, they even seem to touch. Today, it is almost impossible for the AUDIENCE (i.e. real-world viewers) to know what is real or what is virtual. But these methods carry two significant drawbacks. One, they are not in real-time. Two, the only way to see these images are through an apparatus, such as a monitor, television set, theatrical screen, phone, or goggles. The apparatus acts as a “barrier” between reality and film. The audience always knows these images are in the “film world”, not in reality. It would be impossible to recreate the effects in real-life (e.g., on stage in a play, on a real-world object, in a backyard, or other real-world scenario) for example.

Recent developments in augmented reality have solved some of the problems (see URL video.google.com/videoplay?docid=6523761027552517909, or more recently URL www.t-immersion.com/).

Using data acquisition from real environments, virtual environments are created and combined seamlessly with the real environments, very much like in films. But unlike films, these effects are created in real-time. However, like in films, these effects can only be viewed through an electronic viewing apparatus. An audience member must still view the items through a monitor for example.

Other recent advances have demonstrated the projection of virtual environments on real environments, for example on architecture, as described in U.S. Pat. No. 7,407,297 to Rivera, or on stage as described in U.S. patent application publication 2008/316432 to Tejada. These effects may or may not be real-time, but more importantly effectively eliminate any viewing apparatus. The audience sees these effects in the real world, not on a screen. Although this is a necessary step to eliminate the viewing apparatus, it is not sufficient. You can't project a 3-D character walking on stage, for example. At best, the character can be projected in stereo on the back wall, for example.

Interestingly, it has yet to be appreciated that one can present real-world interactions with digitally-created holographic-like virtual objects (or volumetric virtual objects) without requiring an electronic viewing apparatus. Data can be acquired about physical position or orientation of a real-world physical object (e.g., actor, game player, props, sets, cars, etc.). The data can then be used to determine where or when the volumetric virtual object will be located. A system of computer systems and projectors can project digital images onto the physical world in a manner where digital images appear to fully interact with the object from one or more viewers' perspectives, possibly using a form of Pepper's Ghost technique. Such an approach provides for creating 3-D real-time interactions between real and virtual environments in the real world, effectively eliminating an electronic viewing apparatus, or at least a perception of a viewing apparatus.

Thus there is still a need for providing systems, methods, apparatus, configurations, or other subject matter that provide for allowing physical objects to interact with virtual objects in the real-world.

### SUMMARY OF THE INVENTION

The inventive subject matter provides apparatus, systems and methods in which a real-world object can be made to appear to interact with a volumetric virtual object. One aspect of the inventive subject matter includes a system that allows real-world objects to interact with projected images. The system can include a projector capable of projecting an image on to a real-world object while masking various elements. An image processing computer that controls the volumetric projected images can selectively mask or un-mask portions of the real-world object as desired. One or more sensors can be deployed to acquire object information, which can be fed into the image processing computer. The processing computer can use the object information to determine when or which elements should be masked or un-masked.

Another aspect of the inventive subject matter can include method of interacting with volumetric projected images. In some embodiments, object information is collected relating to a real-world object. For example, sensors can be used to track position information of an object (e.g., performer eyes, hands, props, etc.). An image processing computer can be used to predict movement of the object and then project an image at a predicated location. It is contemplated that the image processing computer could also incorporate a priori define choreography information to aid in determining an expected location.

Yet another aspect of the inventive subject matter is contemplated to including various aspects of the disclosed techniques on a live stage. A stage area can have several systems configure to project volumetric images in the local environment. An intermediary semi-reflective viewing surface can be placed between a viewer and a performer so that the viewer can look through the surface to see the performer. The projectors can then project images on an off-stage Invisible Area, then reflected through the surface to present reflected images to the viewers, who are unaware of looking at reflections. These reflections, if the viewers are not aware that they are reflections, may look like fully dimensional real-life volumetric objects. Other projectors can project images on to a performer or other objects directly. These images may be used to simulate lighting conditions influenced from the volumetric objects, such as shadows, or glowing emissions.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of an environment supporting real and virtual environments.

### DETAILED DESCRIPTION

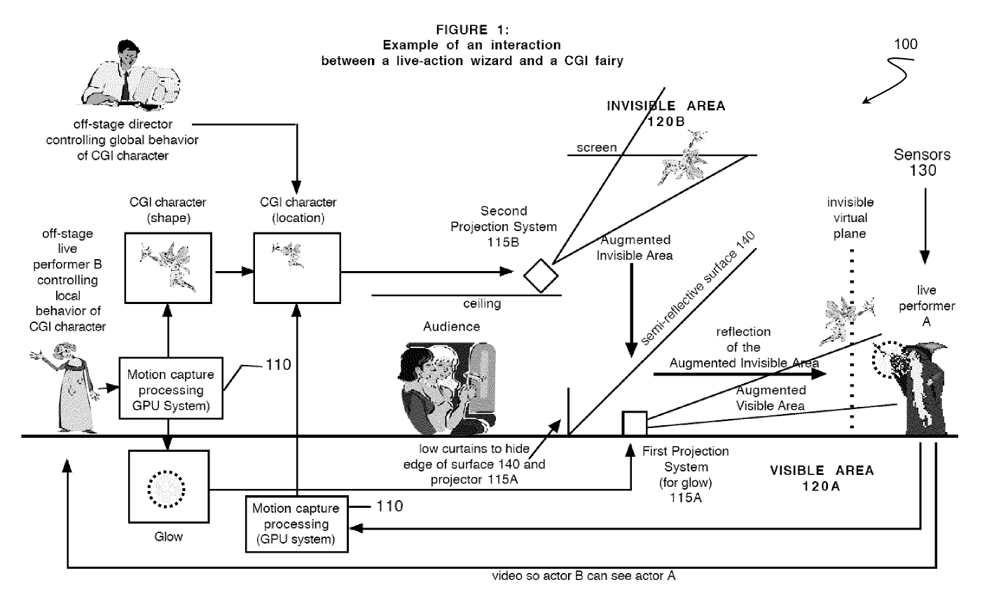

In FIG. 1, presents an example environment 100 where real-world and virtual environments can coexist from the perspective of a viewer (e.g., an audience). In one embodiment, a spatial augmented reality 3-D digital projection system is provided, which comprises the following:

(1) Data Acquisition System

(2) GPU (Graphics Processing Unit) image system 110

(3) First Projection System 115A

(4) Second Projection System 115B; and

(5) Semi-reflective surface 140, which will reflect the image from the Second Projection System 115B projected onto Invisible Area 120B.

With respect to (1), a data acquisition system captures real-time data from Visible Area 120A (i.e. the area visible to the audience, such as a stage, for example) including, but not limited to, the landscape, the object(s), and the performer(s). The system can include an array of sensors 130 (e.g., one or more sensors) to capture data. Sensors 130 can include optical sensors, magnetic sensors, radio frequency sensors, sonic sensors, or other sensors known or yet to be invented.

With respect to (2), the data is then sent to the GPU system 110. The GPU system 110 uses the data to create new virtual entities, characters or effects, generating two distinct sets of images. The first set of images is then sent to the first projection system 115A, and the second set of images is sent to the second projection system 115B. The GPU system 110 can operate as an image processing computer configured to convert, generate, or otherwise render images. In some embodiments, the image processing computer can use the acquired object data to determine how to render or create the images.

With respect to (3), the first projection system 115A projects the first set of images onto the Visible Area 120A. The Visible Area 120A then becomes the Augmented Visible Area. A projection system 115A can include a digital projector and a projector controller. Preferred projectors have high luminosity and high resolution (e.g., greater than 1024×768 pixels). However, it is also contemplated that many small, low resolution projectors (including pico projectors) can also be employed (e.g., multiple projectors having 640×320 pixels) to achieve the same effect.

With respect to (4), the second projection system 115B projects the second set of images onto the Invisible Area 120B (i.e. an area invisible to the audience, such as the top of the stage, for example). The Invisible Area 120B then becomes the Augmented Invisible Area.

With respect to (4), the Augmented Invisible Area is then reflected through a semi-reflective surface 140 (seemingly invisible to the audience) onto the Visible Area 120A. Acceptable semi-reflective panes or surfaces includes those produced by Arena3D™ (See URL www.arena3D.com) or Musion™ (See URL www.musion.co.uk/).

The combination of the Augmented Visible Area with the reflection of the Augmented Invisible Area allows for the creation of virtual objects interacting in real-time in the real world realm.

Many suitable methods can be employed to address the capabilities required for items (1) through (3) above. One set of suitable methods that could be adapted for use include those disclosed in international patent applications WO 2005/096095, WO 2007/052005, and WO 2007/072014 all to O'Connell et al., and U.S. Pat. No. 5,855,519 to Maass.

A preferred system would have the ability to create holographic-looking (e.g., a simulated hologram), or volumetric, CGI objects in the real world, without looking through a viewing apparatus. In other words, a preferred system has the ability to project 3-D images in mid-air, that seem to “float,” basically images that look like holograms.

One method that can be employed includes the Pepper Ghost technique. Mostly used in fairs in the 1800's, the core of the Pepper Ghost technique was basically a large angled glass, which allowed the audience to view only the reflection of a subject, and not the subject itself. The subject was hidden from view (e.g., in the Invisible Area). However, it was useful for the audience to think it was watching the subject itself, not a reflection. The Pepper Ghost Illusion, named after John Pepper, was used widely to create illusions of ghosts, of summoning the spirits (See WO 2005/096095 to O'Connel).

A reflection of the Invisible Area 120B onto the Visible Area 120A through an angled semi-reflective surface 140 creates holographic-looking, or volumetric, CGI objects in the real world, without looking through a viewing apparatus.

Acquisition of Data From the Visible Area

U.S. patent application publication 2008/316432 to Tejada makes extensive references to the use of data acquisition to modify the lighting of the scene. Tejada use infrared cameras, heat technology, and 3-D cameras to acquire data. Another technique not mentioned in this reference is motion capture using sensors on the performers' bodies (e.g., magnetic, optic, reflective, radio frequency, electric, etc.)

Creation of CGI Images From the Data

Once the data is acquired, software can create numerous static or animated effects. The software creates a first set of images, which is sent to the first projection system 115A, and the second set of images, which is sent to the second projection system 115B.

Projection of the First Set of Images onto the Visible Area

The first projection system 115A then projects the first set of images onto the Visible Area 120A. The Visible Area 120A can be comprised of surfaces, like a floor, plants, or a building. It can also be comprised of objects, such as lampposts, cars, or rocks. It can also be comprised of persons. The combination of the Visible Area 120A with the first projected set of images becomes the Augmented Visible Area. The Augmented Visible Area, from the audience's point of view, typically include the lighting effects generated from the volumetric objects created by the second projection system 115B, and may include shadows, or emissive glows. This dramatically increases the realism of the scene.

Projection of the Second Set of Images onto the Invisible Area

This is very much like the previous step, with one major difference. The second projection system 115B then projects the second set of images onto the Invisible Area 120B. Just like the Visible Area 120A, the Invisible Area 120B can be comprised of surfaces, like a floor, plants, or a building. It can also be comprised of objects, such as lampposts, cars, or rocks. It can also be comprised of persons. It can also be comprised of a perfect mirrored environment of environment in Visible Area 120A. The combination of the Invisible Area 120B with the second projected set of images becomes the Augmented Invisible Area. Since the Augmented Invisible Area is off-stage, it is not visible to the audience. The Augmented Invisible Area becomes visible to the Audience as a reflection through a semi-reflective surface 140, creating the appearance of holographic-looking images.

The Augmented Visible Area and the reflection of the Augmented Invisible Area share the same virtual Cartesian coordinates.

If the subjects in the Invisible Area 120B are people, then the Invisible Area may be on the floor, rather than elevated. That means that the representation of the semi-reflective surface 140 on drawing 1 may be rotated 90 degrees around its local X axis from the audience's POV. It could also be vertical, ideal for people. In which case, the representation of the semi-reflective surface 140 on drawing 1 will be rotated 90 degrees around its local Z axis from the audience's POV.

Here we emphasize discrete objects, with high contrasts. A face brightly lit against a black background for example. The subject in the Invisible Area 120B on which CGI images are projected may be 3-D objects, people, or a simple screen.

If the subject is 3-D (any real-life object), its reflection will also appear to be 3-D.

If the subject is a person, like it typically was in the 1850's with the Pepper Ghost Technique, the reflection will of course be 3-D. If the subject is a screen onto which stereoscopic CGI images are projected, the reflection will also be 3-D, although the audience must wear glasses. And because of the laws of optics, one can actually “position” an object anywhere one desires in the real world.

The stereoscopy is carried over to the reflection from the semi-reflective surface 140 only by using anaglyphic-type stereoscopy (i.e. color-based stereoscopy, such as Dolby 3D digital cinema. See URL www.dolby.com.) Polarized-type stereoscopy will not be carried over reflections (i.e. such as Real D 3-D system. See URL www.reald.com.)

So if the Augmented Visible Area and the Augmented Invisible Area are created or influenced from acquired real-time data from the real world, then you would be able to create a real environment interacting with a virtual environment in the real world, without requiring the audience to view the environment through a perceived viewing apparatus.

The audience doesn't see the semi-reflective surface 140; the audience thinks it's watching the real world. The perception is that it's all happening in reality.

### Augmented Reality Without a Viewing Apparatus

Real vs. CGI as the Source Material of the Invisible Area

The advantages of using the real world as the source material of the Invisible Area are twofold. One, there is no rendering, since it's real. Two, the 3-D can be perceived without glasses. But since this real world is lit with CGI lighting, the Augmented Invisible Area will look CG'd. Of course, many times, it will be necessary to project CGI images on a flat screen to create effects that are impossible in real life, such as a dinosaur. In some embodiments, such 3-D images can require glasses.

Pepper Ghost Technique

At the heart of the Pepper ghost technique is the use of a large, transparent, semi-reflective inclined surface, or pane. The pane can be any suitable material that can at least partially reflect a projected image including glass, acrylic, transparent plastics, foils, or other viewing surfaces. By projecting the images onto an Invisible Area, which then is reflected through the pane, we can create reflections that are “floating.” But because the audience doesn't know it's watching a reflection, therefore, it thinks that it is watching a real environment.

A preferred semi-reflective surface pane substantially covers a stage or other real-world setting. Additionally a preferred surface is an intermediary between real-world objects in the Visible Area and the audience. The pane's edges are preferably hidden from the audience using walls or curtains for example. Foils on rolls are best for large venues (see Arenad3D or Musion for acceptable foils).

### Example Embodiment

FIG. 1 illustrates an example where a real-life performer playing a wizard is interacting and talking to a CGI tinker bell fairy that “flies” around his head, and lands on his hand.

The wizard is played by live performer A on stage, the Visible Area 120A. The fairy is a volumetric stereoscopic semi-transparent CGI character controlled off-stage in real-time by performer B. One should appreciate that the wizard represents one type of real-world object, and that any other real-world objects, static or dynamic, can also be used in the contemplated system. Furthermore, the “fairy” represents only one type of digital image that can be projected, but the types of digital images are only limited by the size of the space in which they are to be projected. Naturally the disclosed techniques can be generalized to other real-world objects, settings, or viewers, as well as other digital images.

The fairy looks like a hologram and can disappear behind the wizard's head, and reappear on the other side. For example, the wizard's head can be electronically or programmatically masked so that the fairy image is not projected on the wizard's head. The fairy will even cast a “glow” onto the wizard represented by the dashed circle. The wizard will lift his hand, at which point the fairy will land on the wizard's hand with great precision. One aspect of the inventive subject matter includes supporting dynamic masks (e.g., portions of the projected display that are masked from having displayed image data) that can change temporally or spatially.

One should appreciate that the interaction of the fairy and wizard can be achieved by (1) acquiring data from the wizard, (2) acquiring data from an off stage actor playing the fairy, (3) masking one or more elements on the stage from illumination, or (4) projecting the fairy at expected locations possibly determined by one or more image processing computers. It is specifically contemplated that determining the expected locations can be enhanced by incorporating a prior choreographed movement of real-world objects.

The wizard and the fairy will be able to have a conversation that may or may not be scripted. In other words they can improvise. One should appreciate that the interactions are not required to be scripted beforehand as with previous known systems.

Step by Step Review of Embodiment

The wizard acts and moves and talks in the Visible Area 120A in front of the audience. His performance is captured though a camera, and played live in an off-stage environment such as backstage.

Off-stage performer B, playing the fairy for example, watches the performance of performer A, the wizard, and reacts to it by moving and responding accordingly.

The data from performer B, both body and facial data, can be captured through sensors, motion capture, or other acceptable data acquisition system.

The captured object data of performer B can be used to reshape the body and face of the CGI fairy in real-time using conventional motion capture software, such as Motion Builder™ (see URL www.autodesk.com.)

The image of the transformed CGI fairy with a black background, possibly masked negative space, is then projected using a non-polarized-based stereoscopic projector onto a screen in the Invisible Area 120B, above the stage, hidden by curtains for example.

The image on the screen is then reflected through a large, invisible, inclined, and semi-reflective surface, or pane 140 separating the audience from the wizard. Preferably the paned viewing surface substantially covers the real-world setting, and has its seams hidden from view of the audience.

The resulting stereoscopic reflection gives the illusion of having a flying fairy in the same volumetric space as the wizard.

To make sure the CGI character can fly around the wizard's head, the data from performer A playing the wizard can be captured as well, and fed into the same motion capture software, possibly running on a image processing computer, and/or a projector controller.

The software can then position the fairy in relation to the wizard, near his head, or on his hand, for example, from the perspective of the real-world viewer (e.g., the audience.)

To give the illusion of the fairy flying behind the head of the wizard, the captured data from the wizard also allows for the creation of a mask so that when the fairy flies behind the wizard, she actually “disappears.”

To create a fairy glow, or other digital lighting effects seemingly emanating from the fairy for example, on the wizard, the first projection system 115A projection device must project the glow directly onto the wizard, in the Visible Area 120A. To avoid unwanted glares, the projection device can be placed between the semi-reflective surface 140 and the Visible Area 120A, as opposed to between the audience and the surface 140. In addition, the projectors of the projector systems 115A could also be configured to emit polarized light. The combination of images of formed from polarized light and a polarized filter provides for reducing glare, controlling which images are seen by viewers or performers, or other additional advantages.

The glow may be calculated on a 3-D real-time model of performer A, the same glow then projected onto the real performer A. Basically, the real world becomes “shaded” as if it was a virtual environment.

An off-stage director can use the captured data from both performers to create effects, even in real-time, that are impossible to do by the performers, for example: the fairy doing flips, stopping her wings from flapping when she lands on the hand, dispersing fairy dust if performer B waves a wand, flying away if the wizard shoos her off, turning her glow dark if she's angry, or other effects.

### Additional Considerations

Estimating Point of View: Eye-Line

To the audience's POV, it looks like the wizard and the CGI fairy live in the same Cartesian coordinates (i.e. the same world). But to the wizard's POV, there is no fairy. Yet to make the effect convincing, the wizard must be able to look the fairy in the eye. The glow that is actually projected onto him would help but not be sufficient. Besides, there may not be a glow in other situations. Another solution is to give him a visible point of reference (such as a red dot) controlled by the CGI software that is projected off-stage behind the audience for example. A third solution is to provide various discreet video playbacks of what the audience sees. In a preferred embodiment, an indicator is visible to the live performer, but invisible to the audience. The indicator may also be a “reversed” reflection, in which the Augmented Visible Area and the reflection of the Augmented Invisible Area (the combination being what the audience sees) are captured by a video camera apparatus located behind the audience. The captured image is then projected onto the floor, between the semi-reflective pane 140 and live performer A (where the First Projection System is located.) Live performer A then sees a reflection of what the audience sees by simply staring at the semi-reflective pane 140 (although it looks like he is staring at the audience.)

Supporting Virtual Performers

Performer B playing the fairy doesn't have to be physically near the wizard. Performer B can be in geographically separated (e.g., by more than 10 Km), possibly in another country.

One can have plays involving several CGI characters, all in different countries, very much like the popular “virtual life” websites (such as URL www.SecondLife.com), but instead of the characters appearing in a virtual world, they actually appear on a live stage, and interact with live performers.

Manipulation of Virtual Objects: Juggling

Dramatic examples include a live performer juggling CGI objects. Using physics-based dynamic software, the objects can adjust not only to the location of the hands, but to their velocity and inertia as well. The objects can organically “find” the hands (as opposed to a performer juggling real objects, where the hands must find the objects), so the juggler never “drops” a ball. The CGI objects can move, talk, and even dance all in real-time.

Manipulation of Virtual Objects: Yoyo

Another application is a performer playing with a virtual yoyo. Same principles apply as with Juggling.

Support for Audio: Music

Musicians would be able to play air guitar, only from the audience POV, the musician would look like they are holding a real guitar. Dependent on frame rate and resolution, the guitar can look realistic—until it starts talking and has an attitude.

Adapting a Real-World Setting: Support for Virtual Environment

Other applications include the real environment adapting to the virtual environment. Examples include a CGI character walking and touching a real bush for example, where the bush would move accordingly. A low-tech solution is for a puppeteer to hide behind a bush and move it on cue. A high-tech solution would be robotics, where robots synched to the same data would move the bush.

Adapting a Real-World Setting: Virtual Spray Can

Using an air mouse, a performer in the Visible Area 120A can write in mid-air, and the letters would look like they are floating.

Adapting a Real-World Setting: Night Sky

One thing that is impossible with existing known technologies relating to projecting on the real world (e.g., U.S. Pat. No. 7,407,297 to Rivera, and U.S. 2008/316432 to Tejada) is the ability to seemingly project on nothing. The disclose system allows for such a thing. The user could seemingly project onto the night sky, for example.

Adapting a Real-World Setting: Far, Far Away Landscapes

Another application impossible with the known existing projection systems is that since the Augmented Invisible Area is projected onto a relatively close pane, using the right stereoscopic calculations, one can project (or give the illusion of projecting) onto mountains that are miles away. You could create a virtual flock of birds that would circle a mountain, or even Godzilla walking behind the mountains and approaching. The stereoscopic calculations of the virtual environment become critical to the success of this effect.

### Additional Concepts

The following additional concepts are considered to be included in the inventive subject matter.

Data File Support: Synchronization

Projected digital images and their choreography can be synchronized with other data streams (e.g., include audio, video, tactile, etc.). For example, one can create synchronized real-time CG images directly on a fountain (e.g., Bellagio Fountain in Las Vegas). Rather than synching hundreds of individual lights, one can utilize one or more digital projectors to create a light show that is synched to an audio track and projected solely on each specified water jet. If a lighting data stream or file is not available, one simply videotapes a current show, and uses this to create a sync track into the animation software. This system would only use the first projection system, and, in a more controlled environment, the second projection system as well. Some known suitable techniques are employed by Easyweb™ (See URL www.easyweb.fr/slideshow.html).

Data File Support: Using Audio as Input

Ambient noise, or other locally generated real-world sounds, can be included as input into a projection system. For example, a person could be lit if he screamed. A car would be lit if it honked. The ocean would turn bright red when the wave crashed into the rocks. In other words, one could “paintscape” using audio inputs from the world, as opposed to visual ones only.

Digitally Painting: Painting 3-D Real World Objects, i.e. “PaintScaping”

A 3D model of the real-world object can be created in a computer using 3D computer graphics software. Using the first projection system, the user can “paint” on the 3D model using well-known 3D paint software. Using one or more projection devices, the same brushstrokes can be applied to the real-life subject at the same time, or played back as desired.

The user can then “paintscape” a subject that is not physically nearby. For example, one could paint the real statue of liberty in real time from Los Angeles. In other words, the input of the first or second projection system can be remote.

Digitally Painting: Remote Painting

As above, with additional features a 3-D real-world object can be painted remotely via a packet switched network (e.g., the Internet), possibly through a web site or web-based service. It is also contemplated that such a service could be a for-fee based business.

Digitally Painting: Precision

Using paintscaping, a user would be able to light objects with the surgical precision of CGI software. As an example, a statue could be lit from a projector located at some distance (e.g., 150 feet or more away), where nothing else would be lit, thus having no lighting spill whatsoever. It also contemplated that a paintscaping computer system can be configure to automatically conduct edge detection of objects and only paint within desirable lines or edges.

Image Processing: No Distortion

In some embodiments, there is little need for correcting or compensating for distortions. This can be achieved, because the digital images are created/painted and projected directly on a 3-D surface as opposed to having to adjust the digital images, after they are created or recreated.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for allowing a real-world object to interact with a virtual object, the system comprising:
a first projection system configured to project a digital image on a real-world setting; and
an image processing computer configured to control the first projection system and to mask a first element of the setting while projecting image data on a second unmasked element of the setting.

2. The system of claim 1, further comprising a data acquisition sensor array configured to acquired object data regarding position information of a real-world object within the real-world setting.

3. The system of claim 2, wherein the sensor array comprises two or more sensors.

4. The system of claim 2, wherein the image processing computer is further configured to use the object data to determine expected position of the real-world object as a function of time.

5. The system of claim 4, further comprising a second projection system configured to project a second image under control of the image processing computer, and where the second image is projected as a function of the object data.

6. The system of claim 1, further comprising a real-world semi-reflective surface placed as an intermediary between a real-world viewer and the real-world setting.

7. The system of claim 6, wherein the second projection system projects an image on an invisible area, where a reflection of the image is then carried to the real-world setting, through the semi-reflective surface, in a manner that is invisible to the real-world viewer.

8. A method of interacting with a virtual image, the method comprising:
acquiring object data from a plurality of sensors that track position information of a real-world object in a real-world setting;
providing an image processing computer configured to determine an expected position of the real-world object within the real-world setting as a function of the object data; and
using a first projection system to project a digital image at a viewing location based on the expected position in a manner where a real-world viewer perceives the digital image to be in proper relation to the real-world object.

9. The method of claim 8, further comprising incorporating a priori choreography information into the function to determine the expect location.

10. The method of claim 8, further comprising capturing data of a second real-world object outside of the visible real-world setting, and using the data to render the digital image.

11. The method of claim 10, wherein the second real-world object is a live performer outside the view of the viewer.

12. The method of claim 8, further comprising providing an indicator visible to the real-world object yet invisible to viewer that indicates where the digital image should be from the perspective of the audience.

13. A stage for live performances, comprising:
a first projector system having a first projector and a first projector controller;
a second projector system having a second projector and a second projector controller;
an intermediary semi-transparent viewing surface located between a real-world viewer and a real-world object;
wherein the first projector displays a digital image on a viewing surface visible to the real-world viewer; and
wherein the second projector displays a digital image on a viewing semi-reflective surface invisible to the real-world viewer, the digital image representing a holographic object.

14. The stage of claim 11, wherein the semi-reflective surface provides for the viewer to see the real-world object and the holographic-looking objects at the same time.

15. The stage of claim 11, wherein the second projection system comprises an anaglyphic stereoscopic filter.
